(19) United States
(12) Patent Application Publication
(10) Pub. No.: US 2026/0252324 A1
(43) Pub. Date: Aug. 27, 2026

(54) COMPUTER-INTEGRATED LOW-CODE/NO-CODE DATA COLLECTION SYSTEM

(71) Applicant: AIRTH, INC., Tucson, AZ (US)

(72) Inventors: Ferhat Erman Koc, Tucson, AZ (US); Abinash Moharana, Tucson, AZ (US)

(21) Appl. No.: 19/061,320

(22) Filed: Feb. 24, 2025

Related U.S. Application Data
(60) Provisional application No. 63/557,245, filed on Feb. 23, 2024.

(51) Int. Cl. G06F 8/36; G06F 8/35; G06N 5/022; G06Q 30/0601

(52) U.S. Cl. CPC G06F 8/36; G06F 8/35; G06N 5/022; G06Q 30/0641

(57) ABSTRACT

A computer-implemented method for providing a low-code customizable layered functionality to integrate and facilitate data-driven decision-making. The method includes using a processor to collect data from a plurality of sources. The method further includes using the processor of the computer to gather said data and push to said system, using the processor to integrate the data within the system utilizing an integrated graph model ontology, and using the processor of the computer to process data. The method further includes using the system to analyze the data gathered and perform calculations with the use of algorithms, using the system to generate code engines configured to process input data types, and using the system to facilitate user feedback.

### CROSS-REFERENCE TO RELATED APPLICATIONS

This application is a non-provisional and claims benefit of U.S. Provisional Application No. 63/557,245 filed Feb. 23, 2024, the specification of which is incorporated herein in their entirety by reference.

### FIELD OF THE INVENTION

The present invention is directed to computer systems and is more particularly directed to providing an optimized effective and efficient operational layered low-code/no-code computer-integrated platform system with collaboration properties for seamless integration and contextualization of data, facilitating data-driven decision-making and fostering optimization.

### BACKGROUND OF THE INVENTION

Globally, many individuals utilize and rely on critical minerals like lithium, cobalt, copper, nickel, gold, and several other elements for everyday use. These uses include energy sources, jewelry, electronics, material fabrication, and production of other commercially available items. The demand for these products has become more and more important while globally there is a push towards renewable energy sources via solar panels, wind turbines, and other items used to build the infrastructure required to connect these items to the grid. Furthermore, there is a demand for electric vehicles to eliminate the dependency on fossil fuels and cleaner energy vehicles.

Many challenges can result from the higher demand for these resources. There are geopolitical risks where the concentration of critical mineral resources in specific locations can cause unwanted tensions between countries, terrorist activities, and even wars. Environmental concerns greatly affect the way resources are mined for and quantities, thereby more sustainable, reasonable, and responsible mining practices are required to meet these challenges. Additionally, there are technical limitations and struggles with storing, analyzing, and optimizing data and interoperability between systems which inhibits effective workflow and optimization. As market demands and environmental regulations change, it is required that systems in place are more quickly responsive to changing data that drive decisions and ensure quick adaptive changes. Thus, a heretofore unaddressed need exists in the industry to address the aforementioned deficiencies and inadequacies.

### BRIEF SUMMARY OF THE INVENTION

It is an objective of the present invention to provide systems, methods, and non-transitory computing media that allow for providing an optimized effective and efficient operational layered low-code/no-code computer-integrated platform system with collaboration properties for seamless integration and contextualization of data, facilitating data-driven decision-making and fostering optimization, as specified in the independent claims. Embodiments of the invention are given in the dependent claims. Embodiments of the present invention can be freely combined with each other if they are not mutually exclusive.

Embodiments of the present disclosure provide a system and method for providing a system to support many industries, and allow a user to collect, review, organize, and share data, and present the same in a user-friendly visual drag-and-drop platform system. Briefly described, the present disclosure employs a computer-implemented method for providing a low-code/no-code customizable layered functionality system to integrate and facilitate data-driven decision-making utilizing the processor of the computer to collect data from device Internet of Things (IoT) sensors, operational databases, and/or third-party application programming interfaces. The system also uses the processor of the computer to gather said data and push it to said system and integrate the data within the system utilizing an integrated graph model ontology, including processing data within an open platform system while maintaining distributed event streaming within the system. Further, not only can many different AI algorithms (Random Forest, Decision Tree, Deep Neural Networks, Convolutional Neural Networks, Graph Neural Networks, etc.) be used within this system but also new ones can also be generated. The system provides end-to-end encryption to secure data and formulate relationships between the data and to assist with analyzing the data gathered and performing necessary calculations with the use of provided, machine, or client-derived algorithms for easy decision-making and facilitating user feedback.

One of the unique and inventive technical features of the present invention is the generation of code engines for new input types in response to natural language input. Without wishing to limit the invention to any theory or mechanism, it is believed that the technical feature of the present invention advantageously provides for seamless integration and contextualization of any kind of data for use by a user without requiring the user to code a new engine themself. None of the presently known prior references or works have the unique inventive technical feature of the present invention.

The AI invention of the present invention contributes to enabling lifelong learning of the system. This is because the AI invention is configured to generate new code engines in response to natural language input and the new code engines are added to the greater knowledge graph of code engines, therefore providing a means for interpreting the corresponding data types of the new code engines at any point after.

The AI invention of the present invention also contributes to enabling the use or optimization of different hardware. This is because the AI invention is configured to generate new code engines to process data from new input devices and sources, providing a means for interpreting data from any given input device and/or source through the execution of the machine learning model. These new input devices/sources can then be accommodated at any point.

Any feature or combination of features described herein are included within the scope of the present invention provided that the features included in any such combination are not mutually inconsistent as will be apparent from the context, this specification, and the knowledge of one of ordinary skills in the art. Additional advantages and aspects of the present invention are apparent in the following detailed description and claims.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A is a schematic diagram of the context-generating system of the presently claimed invention.

FIG. 1B is a flowchart illustrating the detailed platform system in accordance with exemplary embodiments of the present disclosure.

FIGS. 1C-1G show flowcharts illustrating the computer-implemented methods of the presently claimed invention. FIG. 1C shows a flow chart of a method for providing context and enabling processing of a plurality of inputs through a low-code customizable layered functionality. FIG. 1D shows a flow chart of a method for user interfacing with the AI system of the present invention. FIG. 1E shows a flow chart of a method for the cloud server interacting with the marketplace database. FIG. 1F shows a flow chart of a method for receiving and adding input code engines to the knowledge graph. FIG. 1G shows a flow chart of a method for receiving and executing a request to execute, transform, and/or compare the data generated by the present invention.

FIGS. 2A-2B are images of the application-based graphical interface in accordance with exemplary embodiments of the present disclosure.

FIG. 3 is an image of the graphical interface depicting several data fetches and queries providing statistical output to the user for decision-making output, in accordance with exemplary embodiments of the present disclosure.

FIGS. 4A and 4B are the flowcharts and the image of the interface for a prompt-driven scenario in accordance with exemplary embodiments of the present disclosure.

FIGS. 5A-5B are graphical illustrations of examples of the system in accordance with exemplary embodiments of the present disclosure.

FIG. 6 is a flowchart illustrating the detailed platform system in accordance with exemplary embodiments of the present disclosure.

FIGS. 7A-7B are flowcharts illustrating data flow in accordance with exemplary embodiments of the present disclosure.

FIG. 8 is a flowchart illustrating a marketplace embodiment of the detailed platform system in accordance with exemplary embodiments of the present disclosure.

FIGS. 9A-9C are images of a simulated interactive spatial environment in accordance with exemplary embodiments of the present disclosure.

### DETAILED DESCRIPTION OF THE INVENTION

The term “code engine” is defined herein as a software application configured to receive raw data as input and filter and format the data in such a manner that a human user can now interpret the information contained in the raw data. These code engines may comprise artificial intelligence models, sequential sets of computer code, a set of object-oriented computer code, or a combination thereof.

The term “contextual processed data” is defined herein as data able to be interpreted by a human user in such a manner that said data can be logically interpreted and linked to other types of data.

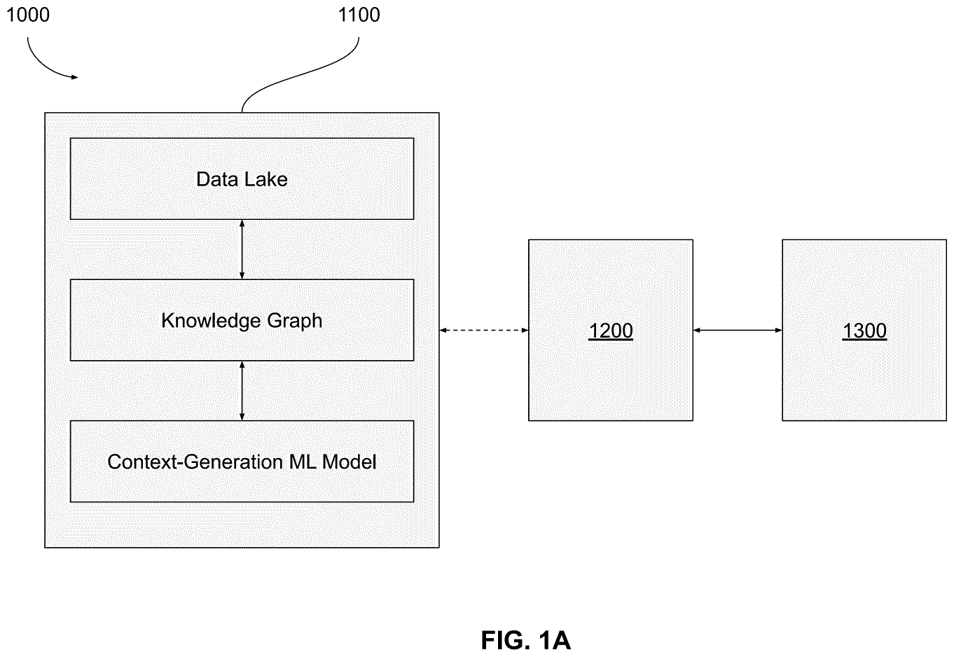

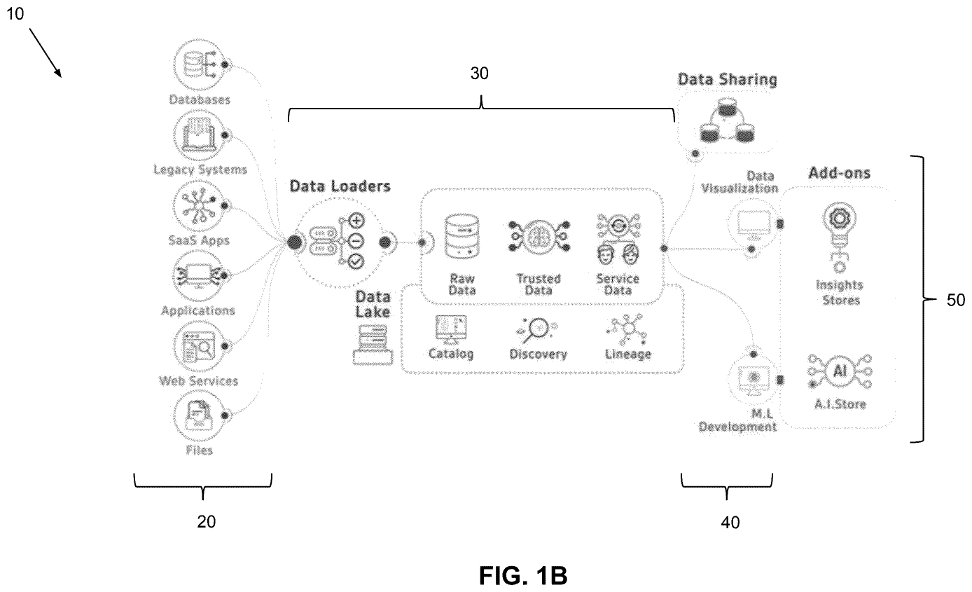

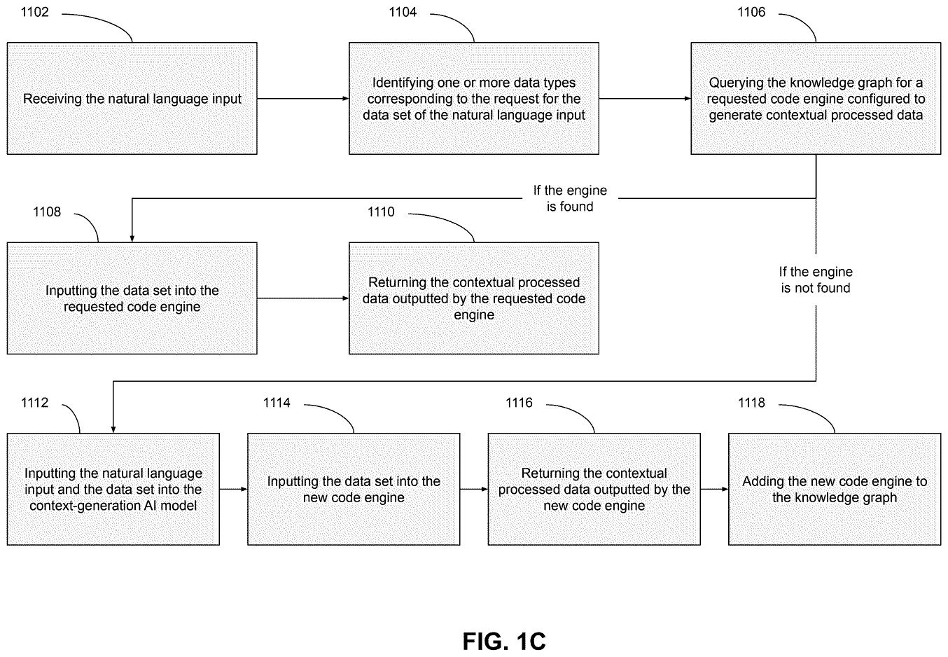

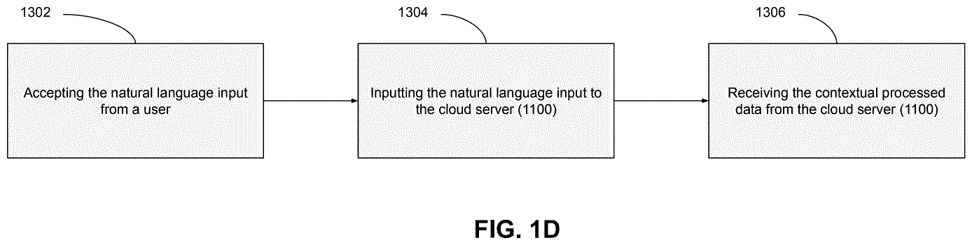

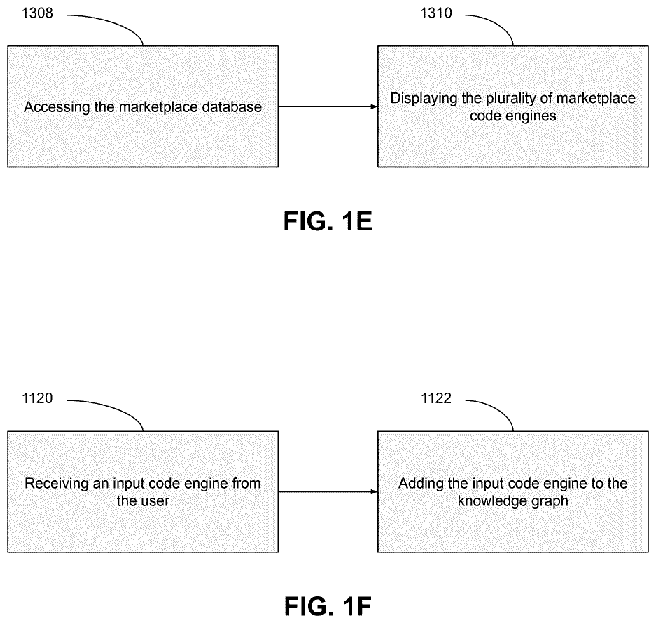

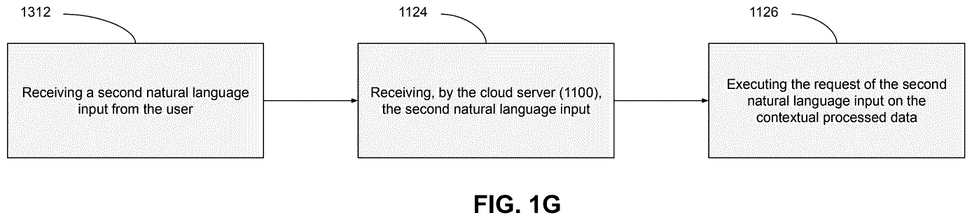

Referring now to FIG. 1A, the present invention features a computer system (1000) for providing context and enabling processing of a plurality of inputs through a low-code customizable layered functionality. In some embodiments, the system (1000) may comprise a cloud server (1100). The cloud server (1100) may comprise a data lake comprising a plurality of data sets, each data set comprising raw data having one or more data types. The cloud server (1100) may further comprise a knowledge graph communicatively coupled to the data lake, comprising one or more code engines, each code engine corresponding to a data type, configured to accept raw data having the data type as input and generate contextual processed data based on the raw data as output. The knowledge graph may further comprise the contextual processed data generated by each code engine of the one or more code engines. The cloud server (1100) may further comprise a context-generation Artificial Intelligence (AI) model trained by a data set comprising the knowledge graph, configured to accept natural language data as input and, if the knowledge graph does not contain a code engine capable of accommodating the natural language input, generate a new code engine based on the natural language data as output.

The cloud server (1100) may further comprise computer-readable instructions for receiving (1102) the natural language input. The natural language input may comprise a request for a data set of the plurality of data sets of the data lake. The computer-readable instructions may comprise identifying (1104) one or more data types corresponding to the request for the data set of the natural language input, and querying (1106) the knowledge graph for a requested code engine configured to generate contextual process data based on raw data having the data type corresponding to the request for the data set of the natural language input. The computer-readable instructions may further comprise inputting (1108), if the requested code engine is found, the data set into the requested code engine, and returning (1110), if the requested code engine is found, the contextual processed data outputted by the requested code engine. The computer-readable instructions may further comprise inputting (1112), if the requested code engine is not found, the natural language input and the data set into the context-generation AI model, inputting (1114), after the new code engine is generated by the context-generation AI model, the data set into the new code engine, returning (1116), after the new code engine is generated, the contextual processed data outputted by the new code engine and adding (1118) the new code engine to the knowledge graph. The new code engine may be placed into the knowledge graph depending on the context of the new code engine. For example, the new code engine may be placed in the knowledge graph in proximity to and/or in relation to processed data or code engines comprising identical or similar data types.

The system (1000) may further comprise a processor (1200) communicatively coupled to the cloud server (1100), configured to execute computer-readable instructions. The system (1000) may further comprise a memory component (1300) operatively coupled to the processor (1200) comprising computer-readable instructions. The computer-readable instructions may further comprise accepting (1302) the natural language input from a user, inputting (1304) the natural language input to the cloud server (1100), and receiving (1306) the contextual processed data from the cloud server (1100).

In some embodiments, the knowledge graph may comprise a plurality of code engines grouped in proximity based on the data type corresponding to each code engine. In some embodiments, the context-generation AI model may comprise a machine learning model, a large language model, a structured model, a convolutional neural network, a recurrent neural network, a feed-forward neural network, or a combination thereof. In some embodiments, the memory component (1300) may further comprise a natural language processing model configured to accept natural language as input and generate conversational responses as output. The natural language input may comprise a plurality of text inputs generated through user interaction with the natural language processing model. In some embodiments, the cloud server (1100) may further comprise a marketplace database comprising a plurality of marketplace code engines.

The memory component (1300) may further comprise computer-readable instructions for accessing (1308) the marketplace database and displaying (1310) the plurality of marketplace code engines. In some embodiments, the cloud server (1100) may further comprise computer-readable instructions for receiving (1120) an input code engine from the user and adding (1122) the input code engine to the knowledge graph. The input code engine may be sourced from the user, the marketplace database, or a combination thereof.

In some embodiments, the memory component (1300) may further comprise computer-readable instructions for receiving (1312) a second natural language input. The second natural language input may comprise a request to execute one or more operations based on the contextual processed data, a request to transform the contextual processed data, a request for generating a relationship between the contextual processed data and a separate data set, or a combination thereof. In some embodiments, executing the one or more operations may comprise executing a function that gets a combination of datasets as inputs and returns a different data asset as output. In some embodiments, transforming the data may comprise cleaning up the data, or transforming the data to make it suitable for the subsequent engine operations or transforming the data such that the defined relationships are valid. In some embodiments, generating the relationship between data sets may comprise adding relationships between the data assets, or adding relationships between components of the data assets or adding relationships between properties of the data assets. In some embodiments, the cloud server (1100) may further comprise computer-readable instructions for receiving (1124) the second natural language input, and executing (1126) the request of the second natural language input on the contextual processed data.

In some embodiments, the one or more data types of each data set of the data lake may be specific to mining operations. In some embodiments, the one or more data types of each data set of the data lake may comprise 3D visualization data, blast hole data, drill hole data, block model data, point cloud data, equipment operational data, equipment health data, operator data, mineral processing data, geotechnical data, safety data, or a combination thereof. In some embodiments, the one or more data types of each data set of the data lake may be specific to utility operations, water operations, lumber operations, business operations, agriculture and farming operations, or a combination thereof.

The present invention features a non-transitory computer medium for providing context and enabling the processing of a plurality of inputs through a low-code customizable layered functionality. In some embodiments, the non-transitory computer medium, when executed by a processor (1200), may be configured to execute computer-readable instructions. The computer-readable instructions may comprise receiving (1102) a natural language input, wherein the natural language input comprises a request for a data set of a data lake comprising a plurality of data sets, each data set comprising raw data having one or more data types. The computer-readable instructions may further comprise identifying (1104) one or more data types corresponding to the request for the data set of the natural language input. The computer-readable instructions may further comprise querying (1106) a knowledge graph communicatively coupled to the data lake, comprising one or more code engines, each code engine corresponding to a data type, configured to accept raw data having the data type as input and generate contextual processed data based on the raw data as output, for a requested code engine configured to generate contextual process data based on raw data having the data type corresponding to the request for the data set of the natural language input. The knowledge graph may further comprise the contextual processed data generated by each code engine of the one or more code engines. The computer-readable instructions may further comprise inputting (1108), if the requested code engine is found, the data set into the requested code engine. The computer-readable instructions may further comprise returning (1110), if the requested code engine is found, the contextual processed data outputted by the requested code engine.

The computer-readable instructions may further comprise inputting (1112), if the requested code engine is not found, the natural language input and the data set into a context-generation Artificial Intelligence (AI) model trained by a data set comprising the knowledge graph, configured to accept natural language data as input and, if the knowledge graph does not contain a code engine capable of accommodating the natural language input, generate a new code engine based on the natural language data as output. The computer-readable instructions may further comprise inputting (1114), after the new code engine is generated by the context-generation AI model, the data set into the new code engine. The computer-readable instructions may further comprise returning (1116), after the new code engine is generated, the contextual processed data outputted by the new code engine. The computer-readable instructions may further comprise adding (1118) the new code engine to the knowledge graph. The new code engine may be placed into the knowledge graph depending on the context of the new code engine. For example, the new code engine may be placed in the knowledge graph in proximity to and/or in relation to processed data or code engines comprising identical or similar data types.

In some embodiments, the knowledge graph may comprise a plurality of code engines grouped in proximity based on the data type corresponding to each code engine. In some embodiments, the context-generation AI model may comprise a machine learning model, a large language model, a structured model, a convolutional neural network, a recurrent neural network, a feed-forward neural network, or a combination thereof. In some embodiments, the natural language input may comprise a plurality of text inputs generated through user interaction with a natural language processing model configured to accept natural language as input and generate conversational responses as output. In some embodiments, the non-transitory computer medium may be further configured to access (1308) a marketplace database comprising a plurality of marketplace code engines and display (1310) the plurality of marketplace code engines. In some embodiments, the non-transitory computer medium may be further configured to receive (1120) an input code engine from a user and add (1122) the input code engine to the knowledge graph. The input code engine may be sourced from the user, the marketplace database, or a combination thereof.

In some embodiments, the non-transitory computer medium may be further configured to receive (1312) a second natural language input. The second natural language input may comprise a request to execute one or more operations based on the contextual processed data, a request to transform the contextual processed data, a request for generating a relationship between the contextual processed data and a separate data set, or a combination thereof. In some embodiments, executing the one or more operations may comprise executing a function that gets a combination of datasets as inputs and returns a different data asset as output. In some embodiments, transforming the data may comprise cleaning up the data, or transforming the data to make it suitable for the subsequent engine operations or transforming the data such that the defined relationships are valid. In some embodiments, generating the relationship between data sets may comprise adding relationships between the data assets, or adding relationships between components of the data assets or adding relationships between properties of the data assets. The non-transitory computer medium may be further configured to execute (1126) the request of the second natural language input on the contextual processed data.

In some embodiments, the one or more data types of each data set of the data lake may be specific to mining operations. In some embodiments, the one or more data types of each data set of the data lake may comprise 3D visualization data, blast hole data, drill hole data, block model data, point cloud data, equipment operational data, equipment health data, operator data, mineral processing data, geotechnical data, safety data, or a combination thereof. In some embodiments, the one or more data types of each data set of the data lake may be specific to utility operations, water operations, lumber operations, business operations, agriculture and farming operations, or a combination thereof.

The present invention features a method implemented on a computer for providing a low-code customizable layered functionality to integrate and facilitate data-driven decision-making. In some embodiments, the method may comprise using a processor (1200) of the computer to collect data from device Internet of Things (IoT) sensors, operational databases and third-party application programming interfaces. The method may further comprise using the processor (1200) of the computer to gather said data and push to a system (1000). The method may further comprise using the processor (1200) of the computer to integrate the data within the system (1000) utilizing an integrated graph model ontology. The method may further comprise using the processor (1200) of the computer to process data within an open-system distributed event streaming system (1000). The method may further comprise providing end-to-end encryption within the system (1000) to secure data. The method may further comprise using the system (1000) to formulate relationships between the data. The method may further comprise using the system (1000) to analyze the data gathered and perform calculations with the use of algorithms. The method may further comprise using the system (1000) to generate code engines configured to process input data types. The method may further comprise using the system (1000) to facilitate user feedback. In some embodiments, the system (1000) programming interfaces may integrate across a network to share said data.

In the described system, every data asset is integrated into an ontology, enabling the system to comprehend the contextual attributes of each data asset. This includes an understanding of the data type, its components, associated metadata (descriptive information about the data), and the constituent elements that form the data asset. Furthermore, the ontology facilitates the establishment of relationships between data components across different assets. These relationships may be straightforward, indicating that a specific component in one data asset is equivalent to a component in another. Alternatively, they may involve complex dependencies, such as relationships defined by transformation rules or mathematical formulas.

Similarly, every computational engine within the system is also incorporated into the ontology, in addition to being governed by a data contract that defines the structure of its inputs and outputs. The engine's ontology provides context by specifying the types of data it can process, the metadata requirements, and the validation criteria that must be satisfied for a data asset to be compatible with the engine. For instance, an engine may be configured to operate exclusively on block models that adhere to specific validation criteria, such as horizontal rotations. If tabular data is provided as input, but lacks the necessary metadata or validation parameters required for block models, the engine would raise an exception.

The integration of both data assets and computational engines within a unified ontology forms the foundation of code engines. These code engines can dynamically interpret the structure of required data assets and engines based on natural language inputs by leveraging the ontology's structural framework.

All data assets, computational engines, and the results generated therefrom are systematically incorporated into a knowledge graph. The knowledge graph does not store raw data but instead maintains references to data assets, engines, and derived results. As new results are produced by the system, the knowledge graph continuously expands. Code engines can execute contextualized queries on the knowledge graph to derive insights by analyzing both the lineage of data (i.e., the relationships between data assets, engines, and resulting outputs) and historical results obtained through system operations.

The AI system of the present invention will use the data lake, and its metadata to generate context. The AI will then be trained on this context to understand the questions posed by the user as a conversation or as part of an agentic system. Once it understands the question and its context, it looks through the Knowledge Graph generated as part of the process and data flows to either generate a result that has already been developed or develop a novel flow to generate the result. It can decipher from the above information if all the required data and engines are present in the system or in the marketplace and if not, request the user for information on it. The main technical differentiator is the use of the data and its metadata and flows and its metadata to understand its context. It also stores the results as well as the history of results to be able to derive context and insights. All of it is stored as part of a graph (more specifically a knowledge graph). The invention is the building of a knowledge graph in context with the domain and accessing the same to derive results and insights.

The mining industry deals with a lot of data that is usually siloed. The data also doesn't have any context associated with it leading to one-off projects where joining data between two domains or systems becomes difficult and expensive. This system aims to alleviate this issue by adding context to the data.
Input Data: The data of the data lake that is inputted into the various AI models of the present invention may comprise tabular data, time series data, IoT data, mining-specific data such as block models, blast holes, drill holes, 3D geometry data such as meshes, points, polylines, polygons, or any other data type.
Training Data: The system is designed to convert every type of data into a series of tabular data with context stored as JSON files. Any data that can be converted to these formats can be used for training the system. Presently, all tabular data, time series data, blast hole, and block model data have been used.
Pre-processing Steps: Data processing is part of the system. Data can be ingested and transformed into datasets that use a series of transform steps. The transform steps can range from Python, SQL, or R-based transforms to more domain-specific engines for mining or other domains.
High-level Architecture: A combination of feed-forward neural networks and recurrent neural nets is used in the initial process. This is then enhanced with the use of graph neural nets. The AI system of the present invention may be executed within cloud-based containers. The neural networks implemented in the present invention may use supervised and reinforced learning.
Output Data: The AI models of the present invention generate contextual processed data. The output of the system can be sent to dashboards and graphs, and processed further to derive insights as well as stored in a knowledge graph to generate the context for future versions of the system. In some embodiments, the outputs of the neural networks and models may be fed back into the system as training data.

To improve over the shortcomings described in the Background, this disclosure is generally related to providing an optimized, effective, and efficient operational layered low-code/no-code computer-integrated platform system with collaboration properties for seamless integration of data, facilitating data-driven decision-making and fostering optimization.

FIG. 1B is a flowchart illustrating the detailed platform system 10 in accordance with an embodiment of the present disclosure. FIG. 1B is a diagram illustrating the integration of various aspects engaged by platform system 10. Platform system 10 receives data from sources including but not limited to Internet of Things (IoT) devices from vehicles, phones, aircraft, boats, and the like to provide data related to resources utilized within the vehicle, phone, aircraft, boats, and the like for performing algorithmic calculations to analyze. These data sources can be fuel and water consumption quantities of vehicles, including trucks and aircraft, the weight of the materials gathered, the location of the vehicles for timing-related matters, and how much emissions the vehicles are releasing. With this data being pushed into the system, various queries, algorithmic calculations, and groupings of the data can be utilized to make core decisions and stored for future use.

Further, FIG. 1B details the levels/steps 20, 30, 40, and 50 of the system. Detailing the first level 20 where data is acquired from multiple and diverse sources, including but not limited to databases; legacy systems, cloud-based systems, i.e., Intergraph Smart® Cloud, Cat® MineStar™ Edge, IoT devices, satellite information, and real-time data, etc. ; other applications, i.e., Access® databases, Excel® spreadsheets; web services, and server and local files including word processing, image files, etc. This data can be sent via Wi-Fi, Bluetooth, or direct input. Once the data is saved within an acquirable source, the system can move to the following steps.

After acquiring data from one or multiple sources, the data is moved into the second system platform level 30. The data is loaded into data loaders which are responsible for mass upload and download. The data loaders fetch data from various sources and can store a multitude of records and can bulk transfer the data. The data collected is then earmarked for transfer to a data lake for storage, organization, optimization, and processing utilizing the system prior to querying for calculations performed with the system and specific to the needs of the user.

Lastly, the data is processed and displayed or shared in a final location 40. Here, the data can be presented visually. Display sources can include remote computers and other remote devices like phones or tablets. Additionally, the data can also be shared with other users, and customers or uploaded into a cloud to disseminate to users, customers, decision-makers, or any others for cost analysis or purchase strategies. Once the data is provided it can be sourced and sent to anyone through email or the like.

Additionally, the data can be processed through provided, user, machine learning (ML), or artificial intelligence (AI) derived algorithms to establish training models and assist with automation of processes and forecasting. AI and ML assist with the development of algorithms that can learn from the data presented and form generation based on current, past, and future data sources.

Additional features can be included in the system and utilized for advanced data processing 50. These add-ons can include artificial intelligence (AI) and insights scores to improve the accuracy of the correct scenario outcomes, predictions, optimization, improvement with production, sustainability, and safety within work sites. Additional add-ons could also include, but are not limited to predictive analytics, MLOps pipelines for lifecycle management and advanced predictive modules, and microservices architecture which rapidly adapts to new requirements, regulations, and technologies without disrupting an entire system.

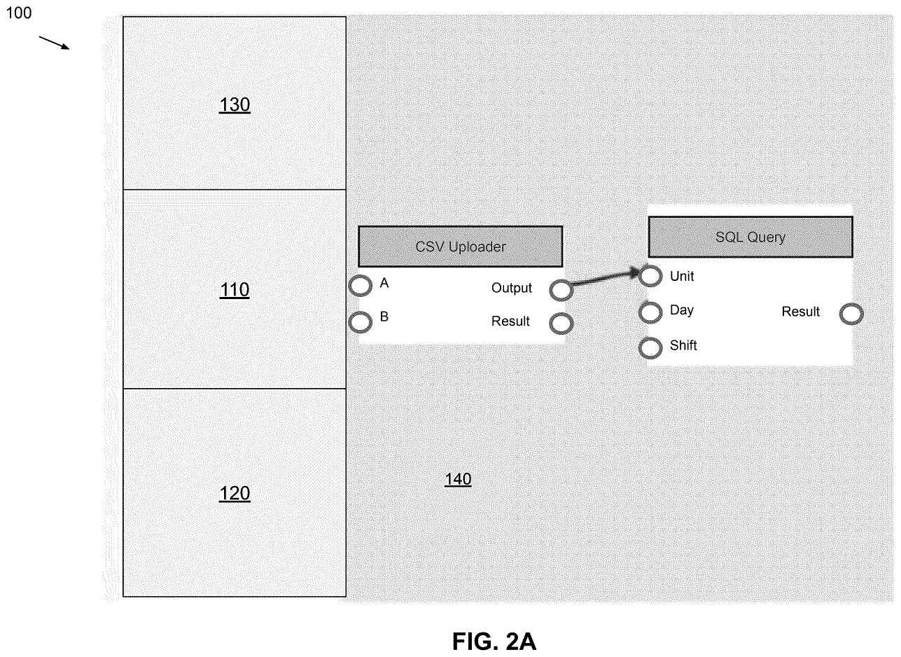

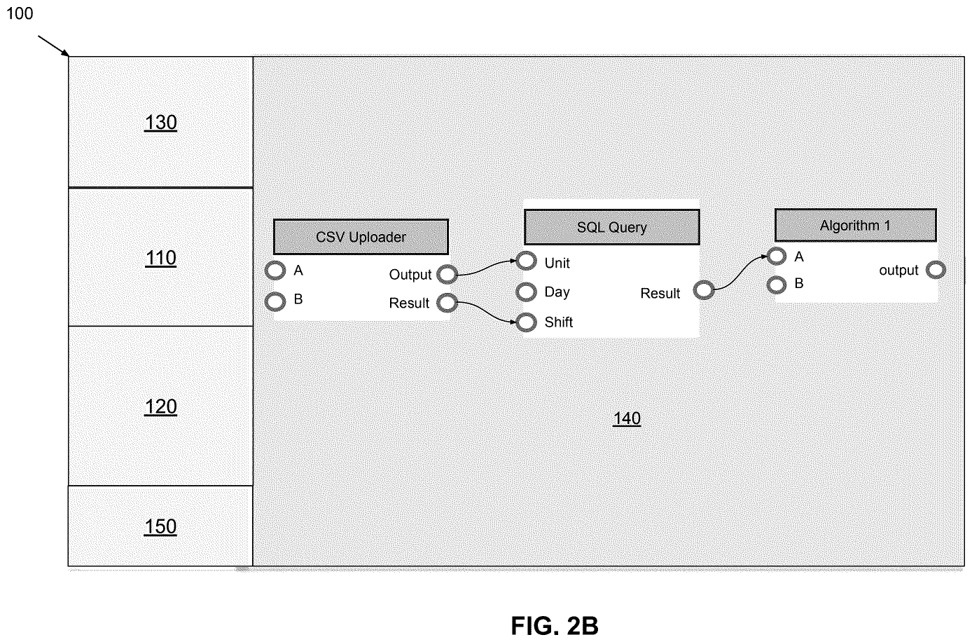

FIGS. 2A and 2B are images of the application-based graphical interface in accordance with the exemplary embodiment of the present disclosure. FIG. 2A is the home screen interface wherein data can be accessed and dropped to craft complex data workflows with little effort and provide output with the user writing little or no code, as desired. Users have the option to modify as needed to suit their specific needs. The data access module 110 provides multiple sources of data where the specific selected feature is moved into the executable window 140. The user can then drag and drop into the executable window 140, a specific input 120, i.e., queries, colors, numbers, input nodes, and Boolean data type values to process the data. Custom user inputs 130 can be designed to filter data, save favorite queries, etc. FIG. 2B is like FIG. 2A wherein data access 110, user inputs 120, and custom filters 130 can be seen. However, the executable window 140 depicts an example upload of data and a query being processed within the system. As can be seen, the result and output from a data source 110 (CSV Uploader) can be diverted to specific query functions 120 (SQL Query) utilizing the drag and drop interface and the result can be pushed through machine-learned algorithms 150 to perform user-specific calculations designed and stored by the system. Basic algorithms are provided to the user; however, there is an option wherein the user can modify code with Python and SQL Script within the system to allow more personalization and flexibility for the users.

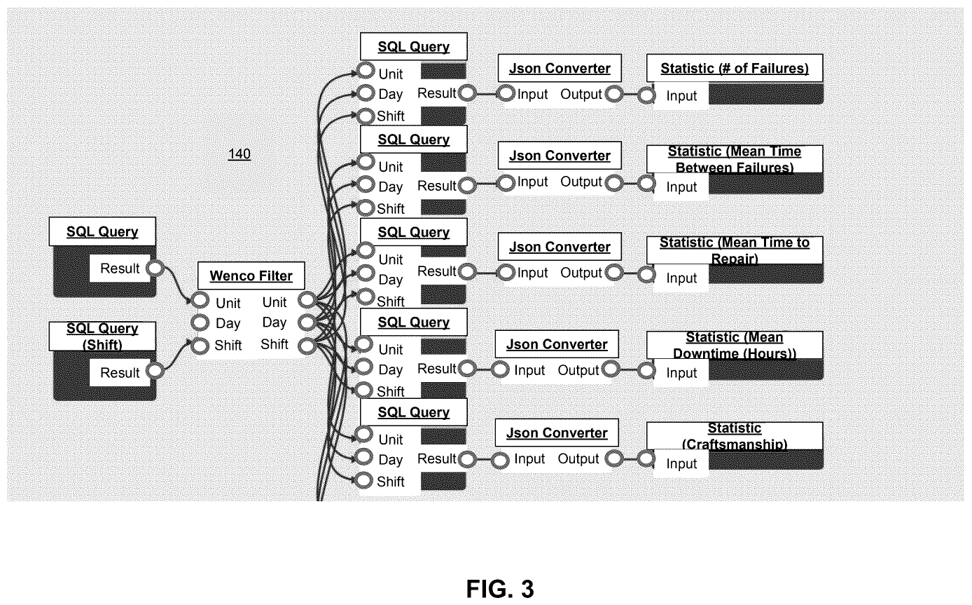

FIG. 3 is a full display of executable window 140 depicting the multiple layers of data that can be filtered through the system solution and providing meaningful, useful decision-making output data. As can be seen, several different factors can be intertwined to see different outcomes and calculations for forecasting and predicting material output, outcomes for labor hour and shift comparisons, consumption of resources, and comparisons to other industry-specific data to gauge the authenticity of the data and thereby providing an avenue to make core decisions related to factors including but not limited to staffing, machinery, quality, and quantities of materials gathered, and output of resources versus input of resources.

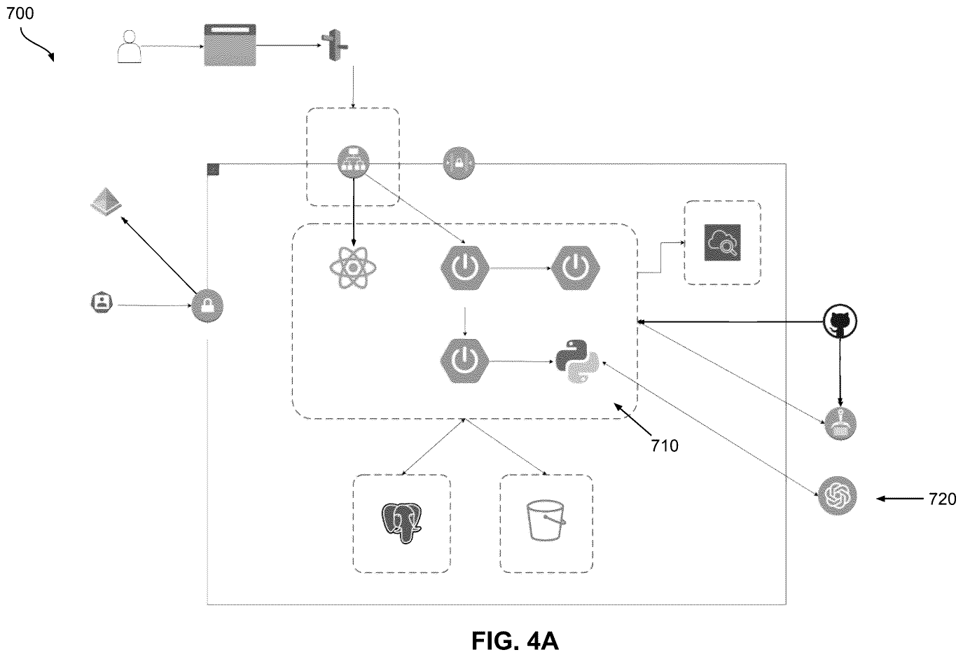

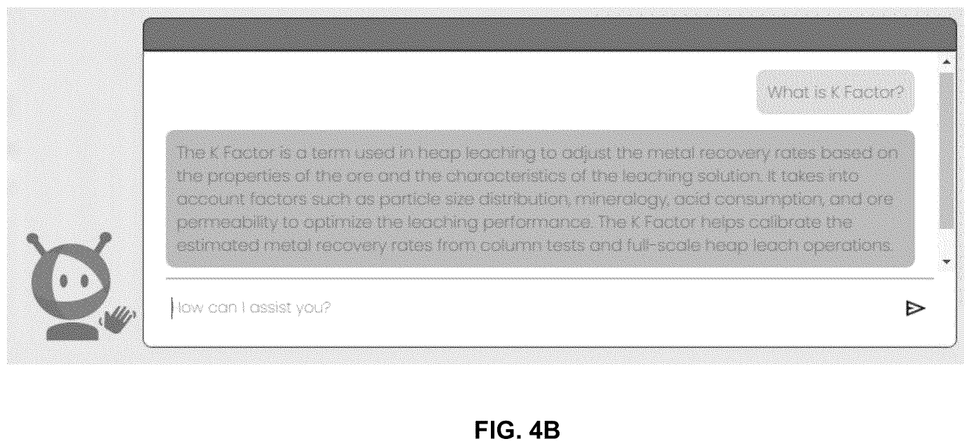

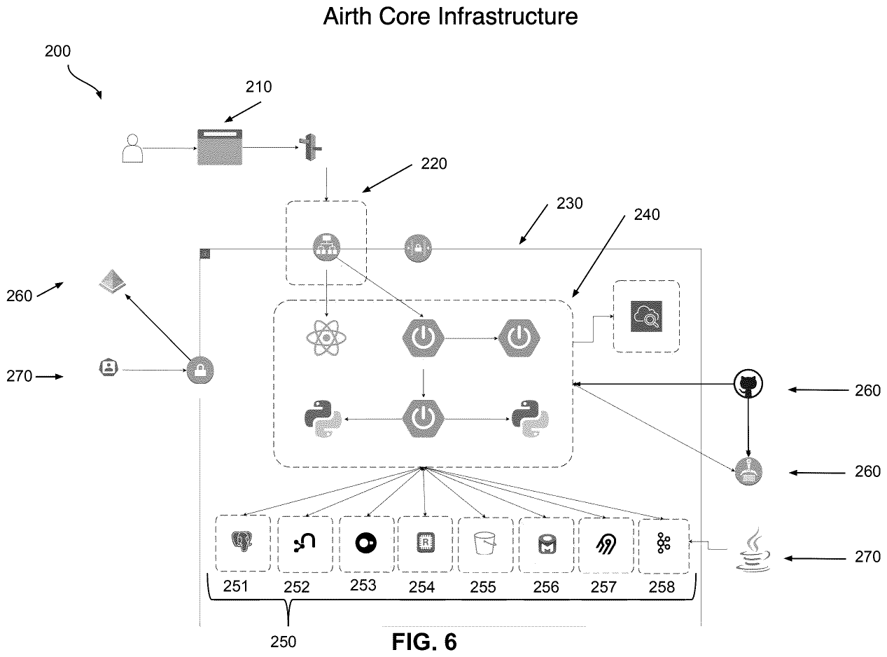

With reference to FIG. 6, FIG. 4A is a diagram illustrating the infrastructure of the system. The detailed platform system 700 receives data from a user. This infrastructure may have many of the same features, structures, and functions as described relative to FIG. 1B and FIG. 6. Services use embedded Large Language Models 710 and external Large Language Models 720. FIG. 4B is an image of the interface for a prompt-driven scenario in accordance with exemplary embodiments of the present disclosure. As can be seen, the system solution provides integration with a machine learning (ML)/AI function to provide instant answers to inquiries while in the field, or after reviewing data.

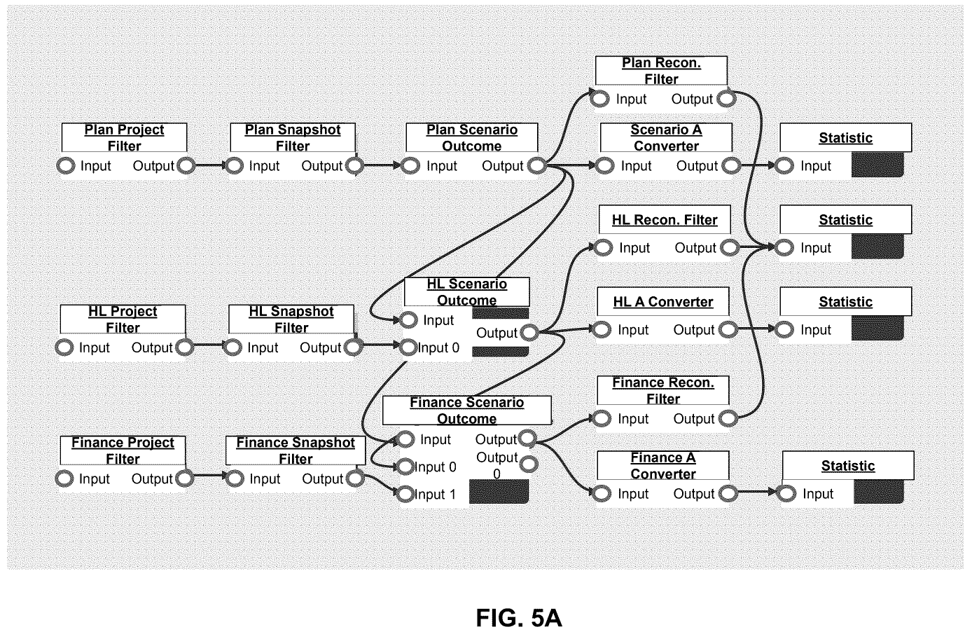

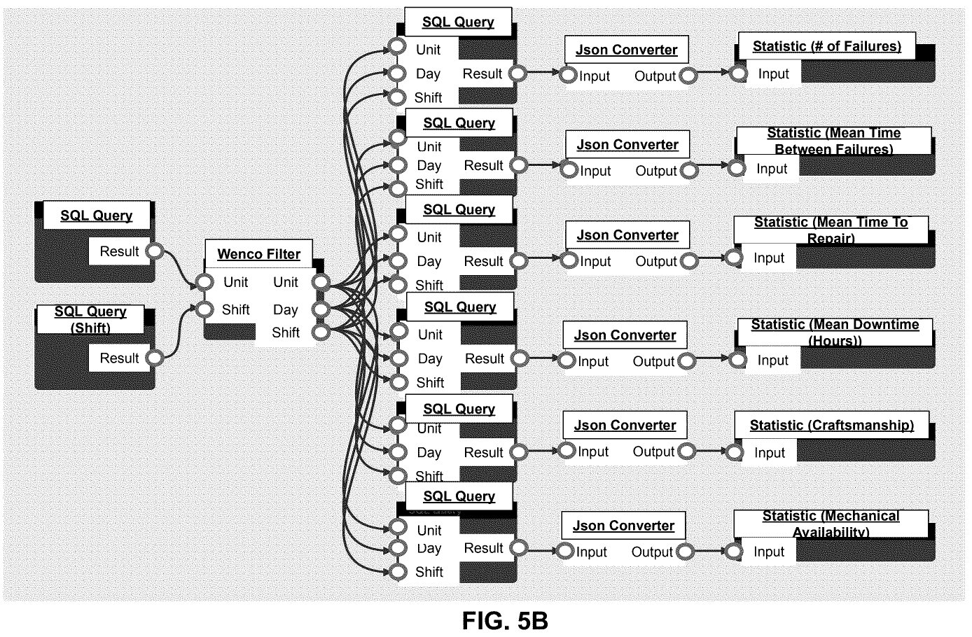

FIGS. 5A-5B are graphical illustrations of examples of the system in accordance with exemplary embodiments of the present disclosure. FIGS. 5A-5B illustrates multiple examples of different workflow scenarios provided by the system which provide resulting output into different filters, queries, and conversion tools to provide decision-making data.

FIG. 6 is a flowchart illustrating the detailed platform system in accordance with exemplary embodiments of the present disclosure. With reference to FIG. 1B, FIG. 6 is a diagram illustrating the infrastructure of the system 10. The detailed platform system 200 receives data from a user, computer, or other devices to perform algorithmic calculations to analyze. The provided data may be fuel and water consumption quantities of the vehicles, such as trucks, the weight of the materials gathered, the location of the vehicles for timing-related matters, how much emissions the vehicles are releasing, and/or any other information related to the site or operations. With this data being pushed into the system, various queries, algorithmic calculations, and groupings of the data can be utilized to make core decisions and stored for future use.

Further, FIG. 6 details a plurality of levels and/or steps 210, 220, 230, 240, 250, 260, and 270. Detailing the first step 210, the user inputs data into a device, i.e., a computer, and sends data, which may be sent via Wi-Fi, Bluetooth, or direct input. Once the data is received, the system can move to the following steps.

After acquiring the data, the data is then sent through a domain name system (DNS) web service and further sent through a load balancer 220 to distribute data dynamically over a set of computing units. The load balancer 220 is integrated with a network access control list that checks the credentials of the user or computer sending in the data before allowing it to enter the developer's private network 230. The developer's private network 230 is secured, such that only authorized users and computers can access the data or content stored within. At this level, data can be sent into a contained orchestration system 240. The contained orchestration system 240 automates the management, scaling, and deployment of containerized applications. The containerized applications may be any application where the software is bundled with all necessary codes, files, and libraries needed to run on any computer or infrastructure.

At the next step, data exits the contained orchestration system 240 and may be sent to a plurality of internal inputs 250, which are inputs within the developer private network 230, or to external inputs 260, which are inputs outside of the developer private network 230. Internal inputs may include relational database systems and relational database management systems, an in-memory data store, cloud storage, and/or a stream processing platform and distributed event store. External inputs 260 may include identity and access management software used for user authentication, docker registries, and source code repositories that may contain the code, or any other development assets. The internal inputs 250 consist of: PostgreSQL for RDS 251 is used to persist data; Neo4J for graph databases 252 is used to persist graph data; DuckDB for in-memory databases 253 is used to analyze the data in memory; Redis for cache servers 254 is used to cache the data for quick retrieval; AWS S3 Buckets for cloud storage 255 is store binary files on cloud; Open Metadata for metadata servers 256 is used to persist metadata of the objects; Airbyte for data collection agents 257 is used as a collector for different data sources; Kafka for message buses 258 is used as message broker.

Additionally, there may also be external outputs 270, which send information from outside the developer private network 230 to specific steps 230, 240, 250 within the developer private network 230 or to the developer private network itself 230, bypassing the load balancer 220. External outputs 270 may include customers, employees and developers of the system or the like, which may access the developer private network 230 through a virtual private network.

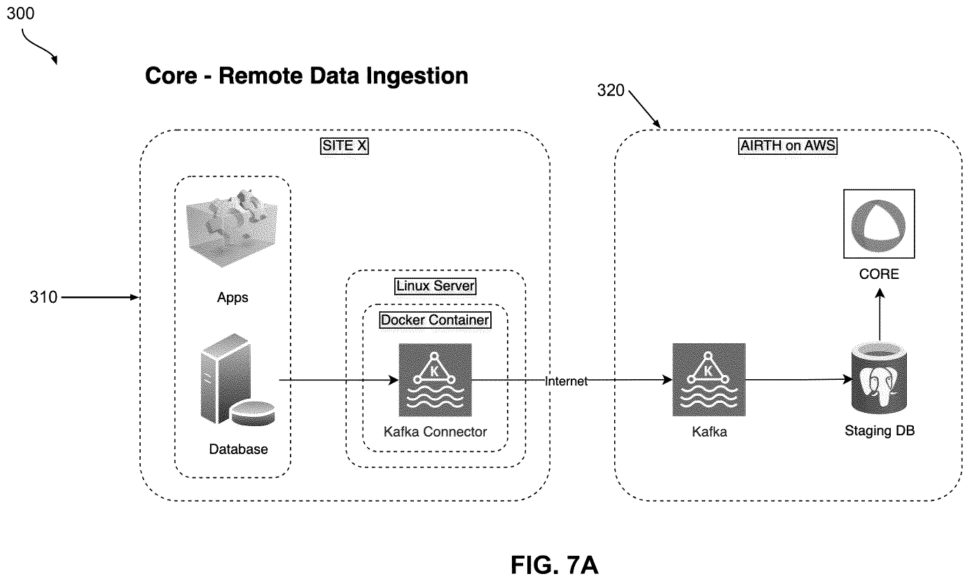

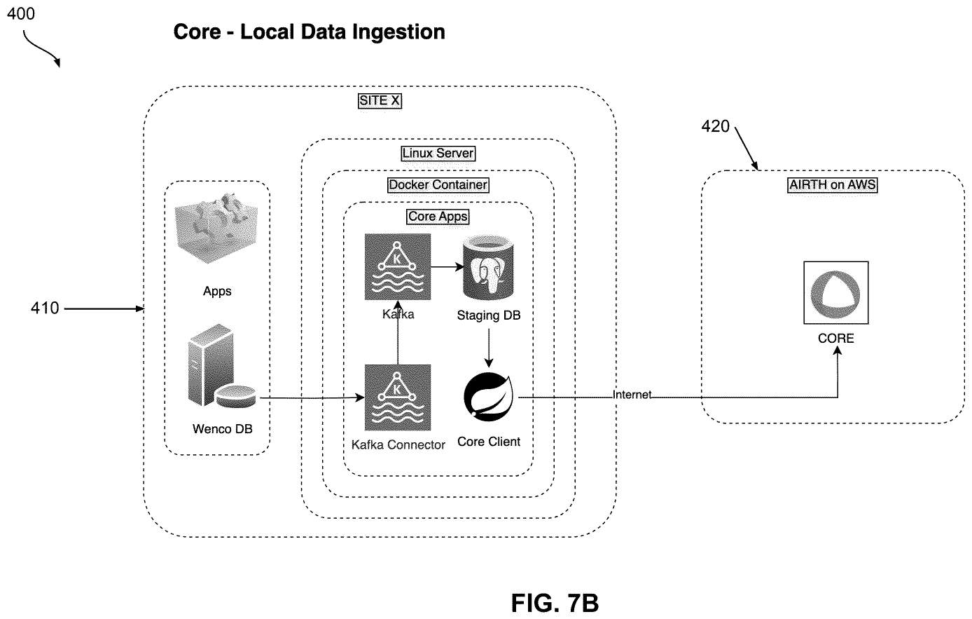

FIGS. 7A-7B are flowcharts of systems 300 and 400 illustrating data flow in accordance with exemplary embodiments of the present disclosure. FIG. 7A shows remote data ingestion from an external site 310 to a server 320 containing the algorithmic system. Data at the external site 310 is streamed or sent to the server 320. The external site 310 and the server 320 may be wirelessly connected by Wi-Fi, Bluetooth, direct input, or through the IoT. Within server 320, the data may first be processed at a stream processing platform and distributed event store, then sent to a staging area before it is sent to system 200 (see FIG. 6). Similarly, FIG. 7B shows local data ingestion system 400 from an external site 410 to a server 420. In this example, data at the external site 410 is steamed, processed, and staged within the external site 410. The staged data is then sent to the server 420 wirelessly by Wi-Fi, Bluetooth, direct input, or through the IoT. The server 420 contains the system 200 (see FIG. 6).

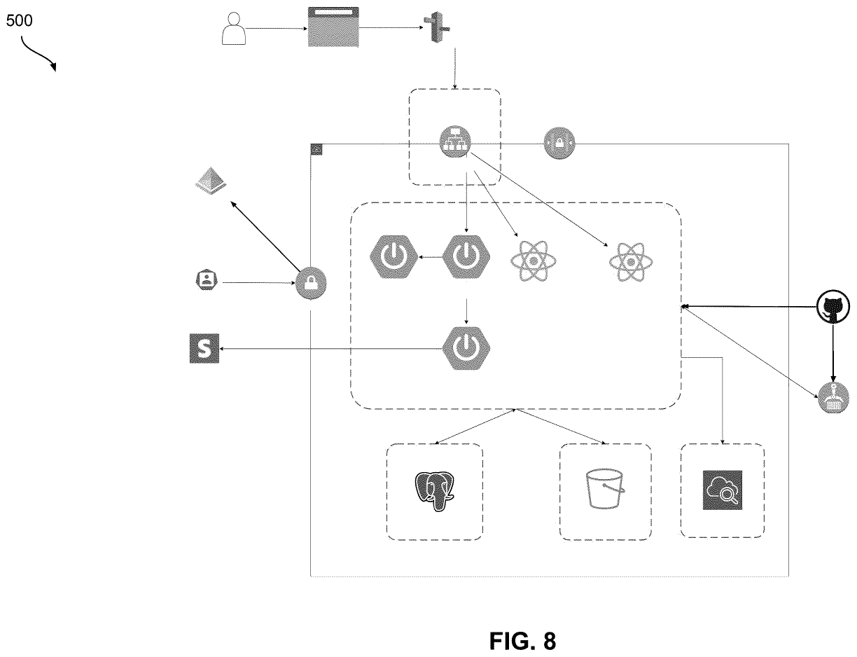

FIG. 8 is a flowchart 500 illustrating a marketplace embodiment of the detailed platform system in accordance with exemplary embodiments of the present disclosure. This infrastructure may have many of the same features, structures, and functions as described relative to FIG. 1B and FIG. 6.

The costs that occur when the flow is run are managed by the user wallet in this system. Also, all the modules of the platform are activated by the user subscriptions in this system. Further, users can also list their flows or components in this system for purchase by other users.

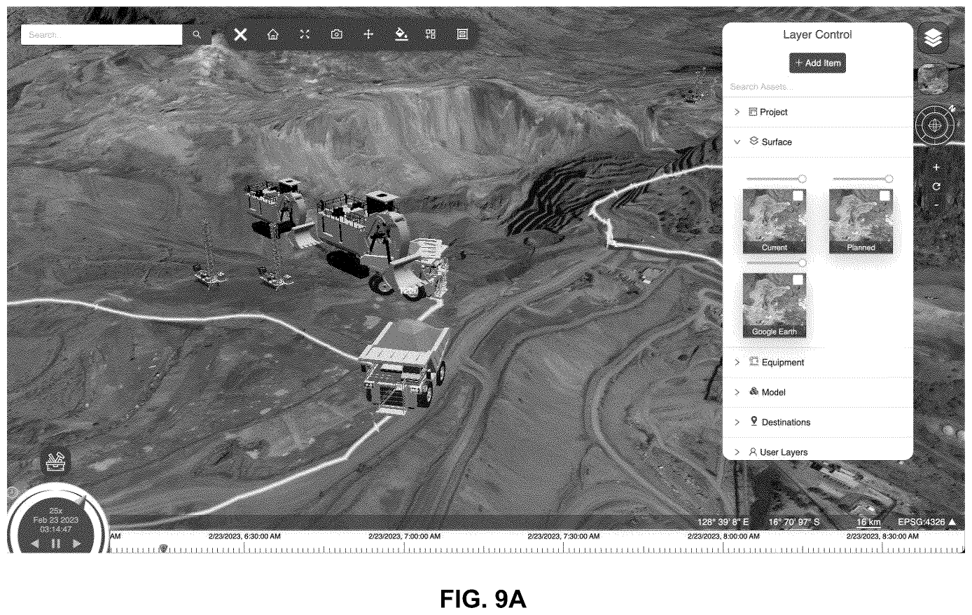

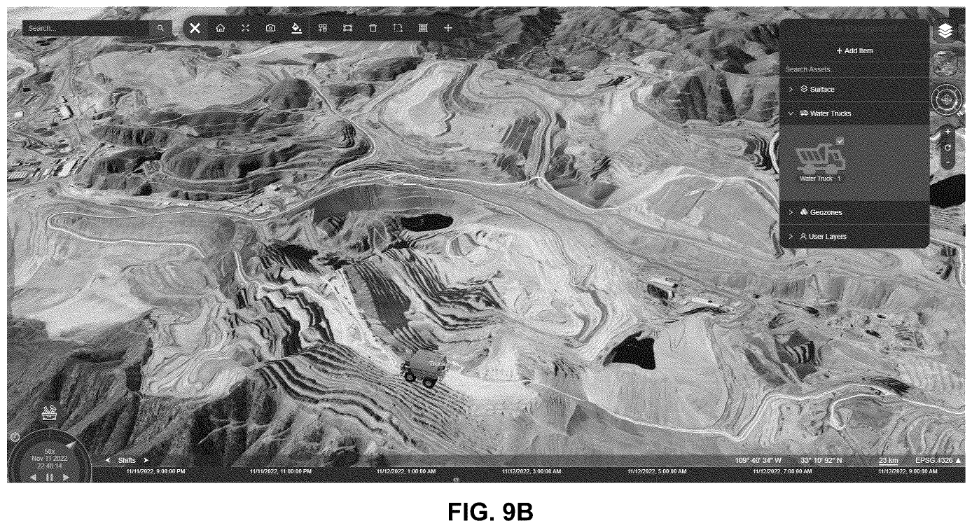

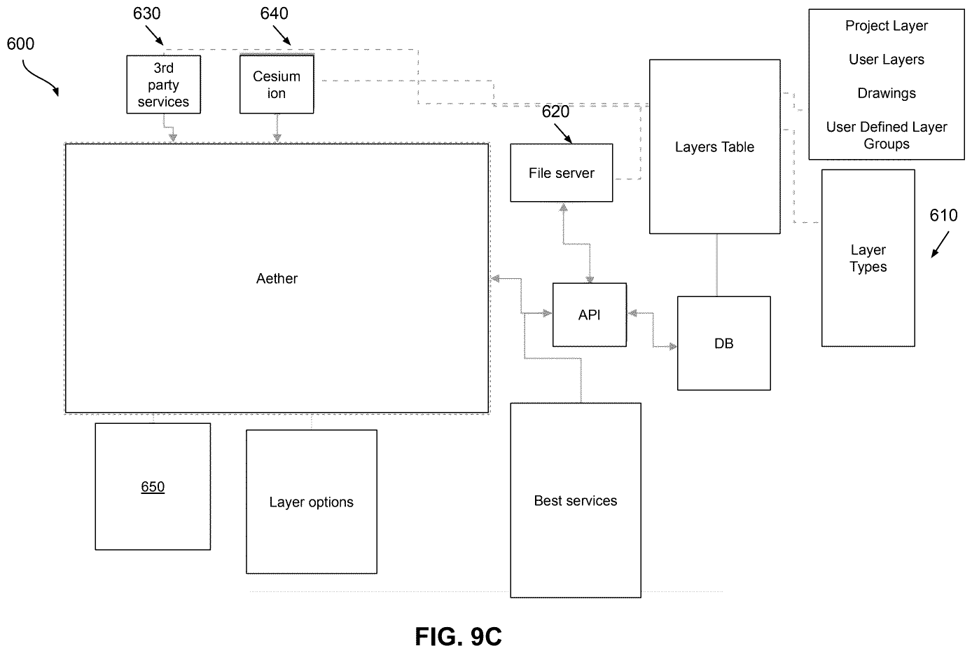

FIGS. 9A-9B are images of a simulated interactive spatial environment in accordance with exemplary embodiments of the present disclosure. As can be seen, the user is provided with the simulated interactive spatial environment displaying a visual representation of operations in near real-time or substantially in real-time. One example of this is showing the location of individual vehicles out of a plurality of vehicles at a site. Additionally, a plurality of routes that can be taken by individual vehicles is also shown, denoting different shovel locations. In another example, the route each individual vehicle is assigned may be highlighted in a different color to show the user what the intended route is for a vehicle, and whether any deviations from that route are taken. The system may be implemented by attaching a tracking apparatus to each of the vehicles in the plurality of vehicles. The tracking apparatus may be a GPS tracker. With reference to FIG. 1B, The GPS tracker is wirelessly connected to send data to the second system platform level 30. The data is then subsequently processed, displayed, or shared in a final location 40, where the collected and processed data regarding the plurality of vehicles may be presented visually to the user in the form of a near real-time simulated interactive spatial environment. The system provides greater awareness to a user about the movement of materials and traffic conditions at the site. In some examples, the tracking apparatus may also gather data on the health and diagnostics of vehicles. Data on the health and diagnostics of the vehicles may include the speed of the vehicle and/or various engine and fuel parameters, such as engine oil level, oil temperature, miles traveled, fuel consumption, fuel level, coolant level, coolant temperature, etc. Additionally, any hydraulic systems on the vehicles may also be monitored for proper function and efficiency. In some examples, a camera may also be mounted to the vehicle so that a user is able to see what the driver of the vehicle is seeing. This may be useful for certain obstacles that may appear on the route that are otherwise not captured by the simulated interactive spatial environment.

FIG. 9C is a flowchart depicting the system 600 that supports multiple data formats 610, including GeoJSON, KML, WMS, MapServer, PointCloud, Raster, FBX, etc. Data can be loaded in three ways. In the first way, data can be loaded from its own file server 620. In the second way, data can be loaded from third-party services 630. In the last way, data can be loaded from the map server Cesium Ion 640. Cesium Ion is a cloud platform that offers tools and data for creating 3D maps and geospatial visualizations. Moreover, users can also draw objects in Aether, such as lines, polylines, and polygons 650.

In the simulated interactive spatial environment, the simulated or graphically generated vehicles may correspond to their real-life counterparts. In a mining industry embodiment, a haul truck in the real world will be simulated as a haul truck and a mining shovel or excavator in the real world will be simulated as a mining shovel or excavator. In some examples, the vehicles may be simulated to scale. In other examples, the scale of vehicles in the simulation will not be accurate to real life.

In one example, a simulated spatial environment may be a site. Objects such as boulders, mountains, and terrain may be rendered using polygonal meshes, and/or subdivision surfaces. A subdivision surface is a curved surface created by dividing or splitting the surface or face of a polygonal mesh into smaller surfaces, to create smoother curves and transmission. This may be useful in rendering piles of rock or sediment, as well as smoothly rendering areas of higher and lower elevations relative to a plane. Within the simulated spatial environment, a user may be able to mark particular areas of interest and create new routes for vehicles to travel on, as it will provide a near real-time simulation of the real-life site. Additionally, measurements and topological information may be gathered on areas of interest, or any area within a simulated space within the simulated spatial environment.

In some embodiments, the present invention may comprise an intuitive low-code platform. The low-code platform may comprise drag-and-drop functionality, allowing for simple model creation without any coding knowledge. The platform may comprise a user-friendly interface designed for ease of use, ensuring a seamless experience for both novices and experts. In some embodiments, the present invention may implement seamless data integration. This may be achieved through extensive connectors across a wide range of data sources, including IoT devices and cloud services. This may additionally be achieved through real-time processing, allowing for near-real-time decision-making based on streaming data. The present invention may implement machine learning and AI integration. The present invention may allow users to build predictive models easily without the need for machine learning coding expertise. The present invention may implement natural language processing, allowing for data to be queries and reports to be generated using conversational language.

In some embodiments, the present invention may implement cloud-native architecture, optimized for efficiency in cloud environments. The present invention may support growing user numbers and data volumes without performance loss. The present invention may offer shared workspaces configured to enable team collaboration on projects in a digital space. The present invention may implement integrated version control, allowing for changes to be managed and reverted to previous versions effortlessly. In some embodiments, the present invention may implement interactive dashboards and 3D visualization of data for in-depth analysis. The present invention may employ AI for efficient data preparation and actionable insights. The present invention may allow operations to be visualized in near-real time.

In some embodiments, the present invention may be implemented in the mining industry. The present invention may be configured for stockpile management and modeling for mining companies. Unpredictable stockpile conditions can disrupt material blending and processing flow. The present invention may streamline stockpile management, ensuring optimal material blend and consistent processing feed, aligning with mining plans for efficient production. The present invention may be used to implement stockpile tracking to ensure accurate inventory levels and allocations. The present invention may be used to implement stockpile planning to align stockpiles with production schedules. The present invention may be used to implement inventory management to maintain material quality and supply consistency.

In some embodiments, the present invention may be configured for environmental, social, and governance (ESG) carbon footprint analysis vs. fuel consumption in fleets. Managing fuel consumption and CO₂ emissions in fleet operations is critical for cost reduction and environmental responsibility. The solution enables detailed tracking of fuel use and emissions, guiding fleets towards optimized efficiency and sustainability, thus supporting ESG compliance. The present invention may be used for emission tracking to monitor CO₂ output for environmental compliance. The present invention may be used for fuel efficiency analysis to identify savings in fleet operations. The present invention may be used for sustainability reporting to support ESG goals with actionable data.

In some embodiments, the present invention may be configured to execute ESG water truck management solutions with open-loop energy. Mining operations face challenges with efficient water distribution, leading to increased costs and environmental impact. The present invention may offer intuitive dashboards and automated optimization, providing real-time insights into water truck activities. This may ensure efficient water usage, enhance dust control, and promote sustainable mining practices. The present invention may be used for water truck route automation to enhance efficiency and optimize resource usage. The present invention may be used for cost management analysis to track expenditures and maintain budget control. The present invention may be used for water consumption monitoring to reduce resource usage and protect the environment.

In some embodiments, the present invention may be configured for material routing analysis for fleet management. Efficient material routing is critical for streamlined mining operations, cost reduction, and increased productivity. The present invention may integrate cutting-edge technology to optimize the movement of materials, ensuring that the right resources are at the right place at the right time. With real-time tracking and advanced analytics, the present invention enhances fleet management and drives operational success. The present invention may be used for route analytics and reporting to provide insights into route efficiencies and bottlenecks. The present invention may be used for operational progress tracking to understand material movement and equipment utilization.

In some embodiments, the present invention may be configured for predictive short-term planning and grade control in gold operations with mine foresight. Gold mining companies often encounter difficulties in metal accounting and financial risk due to delayed and inaccurate blast hole sampling analysis, leading to inefficiencies in production forecasting. The present invention utilizes machine learning for quick and precise metal accounting, reducing financial risk, and improving overall operational efficiency. The present invention may be used for rapid sampling analysis to accelerate metal accounting for enhanced production planning. The present invention may be used for machine learning integration to provide accurate forecasting to mitigate financial risk. The present invention may be used for operational efficiency to optimize gold recovery processes through data-driven means.

In some embodiments, the present invention may be configured for copper heap leach production integrated solutions. In heap leach mining, a lack of precise planning and modeling tools can lead to inefficiencies, higher operational costs, and missed production targets. The present invention may streamline heap leach mining by offering precise planning, modeling, and financial analysis. This boosts efficiency, lowers costs, and enhances profitability through improved process management and data-driven decision-making. The present invention may allow for precision planning to streamline operations with target planning tools. The present invention may allow for advanced modeling to enhance forecasts and operational strategies. The present invention may allow for financial integration to drive profitability with cost-effective analysis.

In some embodiments, the present invention may be applied to utility operations, water operations, lumber operations, business operations, agriculture and farming operations, a combination thereof, or any other industry or sector.

The following are provided as a non-exhaustive list of examples of the subject disclosure, where any examples may be used in any combination or manner:

Example 1: Utilizing an environmental, social, and governance water truck management solution with open-loop energy. Mining operations can face challenges with efficient water distribution, leading to increased fuel, labor, and supply costs, and an additional environmental impact, i.e., reduction in carbon dioxide emissions. The instant invention offers intuitive dashboards and automated optimization, providing real-time data and water truck activities delivered via sensors onboard the vehicles to the application. This assists in making decisions to manage efficient water usage, promotes better dust control, and sustainable mining practices by monitoring use in order to reduce the same where possible. This can include water truck route automation, enhancing efficiency, optimizing resource usage, and providing a cost management analysis via tracking expenditures in order to maintain budget control.

Example 2: Stockpile management. Unpredictable stockpile conditions can disrupt material blending and processing flow. The instant invention streamlines stockpile management, ensuring optimal material blend and consistent processing feed, aligning with mining plans for efficient production. The system provides resources to assist in managing stockpile tracking and planning, ensuring accurate inventory levels and allocations, aligning stockpiles with production schedules, assisting with inventory management, and maintaining material quality and supply consistency.

Example 3: Copper heap leach production integrated solutions with Airth® plan+Airth® Act HL+Airth® Finance+Airth® Aether are sub-platforms that can be integrated into the Core to provide important algorithmic calculations to achieve results. In heap leach mining, a lack of precise planning and modeling tools can lead to inefficiencies, higher operational costs, and missed production targets. These integrated system solutions can streamline heap leach mining by offering precise planning, scheduling, modeling, and financial analysis. This boosts efficiency, helps achieve targets, lowers costs, and enhances profitability through improved process management, auditability, and data-driven decision-making. Further, providing precision planning, streamlining operations with targeted planning tools, advanced modeling, enhancing forecasts and operational strategies, and financial integration to drive profitability with cost-effective analysis. All of these integrated system solutions provide reports to evaluate performance and identify areas that require re-evaluation and adjustment as needed.

Example 4: Environmental, Social, and Governance (ESG) Carbon Footprint Analysis vs. Fuel Consumption in Fleets—Managing fuel consumption and CO2 emissions in fleet operations is critical for cost reduction and environmental responsibility. The system solution enables detailed tracking of fuel use and emissions, guiding fleets towards optimized efficiency and sustainability, thus supporting ESG compliance. This is done via emissions tracking, monitoring CO2 output for environmental compliance, fuel efficiency analysis, identifying savings in fleet operations, sustainability reporting, and supporting ESG goals with actionable data.

Example 5: Predictive Short-Term Planning and Grade Control in Gold Operations with Airth® Mine Foresight—Gold mining companies often encounter difficulties in metal accounting and financial risk due to delayed and inaccurate blast hole sampling analysis, leading to inefficiencies in production forecasting. With the system solution, Mine Foresight utilizes machine learning for quick and precise metal accounting, enabling timely and accurate decision-making, reducing financial risk, and improving overall operational efficiency. This performs rapid sampling analysis, accelerates metal accounting for enhanced production planning, and machine learning integration, provides accurate forecasting to mitigate financial risk, and operational efficiency, and optimizes metal/mineral recovery processes through data-driven decisions.

The subject system solution is geared toward revolutionizing the industry through the introduction of core and marketplace modules. These system solutions integrate cutting-edge technologies such as artificial intelligence (AI) models, optimization algorithms, graph model ontology, and graph neural networks (GNNs), complemented by versatile low-code/no-code and Python-based customization options. This system solution is designed to propel the sector towards fully autonomous and vendor-agnostic operations. The solutions are pivotal in enhancing decision-making, operational efficiency, and sustainability within the mining value chain. The system solutions address influencing global supply chains amidst evolving ESG, electric vehicle (EV) adoption, intergovernmental organizational economic shifts, and heightened safety trends.

While an integration system ties together several aspects, the instant solution introduces a revolutionary low-code/no-code system that empowers mining companies to leverage advanced data analytics and automation. This transformational tool converts extensive planning, operational, product processing, and finance data into actionable insights, facilitating efficient and sustainable decision-making processes.

The system solution's robust data integration system amalgamates data from disparate mining operations into a cohesive ecosystem. The system enhances comprehensive monitoring and analytical capabilities and enables mining companies to optimize logistical operations and achieve substantial cost reductions. For instance, by integrating sensor data across multiple operational fronts, the system solution can streamline the supply chain, potentially leading to a 20% decrease in operational costs through optimized resource allocation and transportation logistics.

The system solution further provides process optimization. This utilizes an array of AI models and sophisticated optimization algorithms; the system solution refines and enhances operational workflows across the mining value chain. This approach not only boosts efficiency but also significantly improves decision-making. An illustrative example of this optimization is the use of machine learning models to predict equipment failure rates, allowing for preemptive maintenance that minimizes downtime and extends equipment life, resulting in a direct impact on profitability and sustainability. The integration of graph model ontology within the system solution revolutionizes how data is structured and analyzed, offering a dynamic way to map the relationships between various entities within mining operations.

Additionally, dynamic data visualization can provide intuitive interfaces for real-time monitoring, the system solution drastically improves user engagement with complex operational data. This capability allows for the visualization of critical dependencies within the mining process, enabling operators to make informed decisions swiftly. Scalable solutions are mining operations that can expand, and the instant system solution provides a graphical model ontology that facilitates the seamless integration of new data points and relationships, ensuring the system's adaptability and scalability. Also, enhanced analytical capabilities are provided in the instant system solution. The advanced data structuring supports sophisticated analytics, allowing for in-depth optimizations and predictions that are highly tailored to the unique challenges of mining operations. For example, by identifying critical path dependencies in the ore extraction process, the system solution can prioritize operations that maximize output and reduce waste, demonstrating a tangible improvement in operational efficiency and environmental impact.

Additionally, GNNs within the system solution represent a leap forward in data analysis, utilizing the richly structured data provided by graph model ontology to predict operational outcomes and recommend optimizations. Advanced neural networks are adept at analyzing the intricate relationships and patterns within mining operations, offering predictive insights that facilitate proactive management and strategic planning. By integrating GNNs, the system solution can, for instance, forecast the degradation of critical machinery components, allowing for maintenance schedules that significantly reduce the risk of unexpected failures and operational disruptions. Other system integrations assist in providing emerging pivotal elements of the system solution ecosystem, aimed at democratizing, and revolutionizing the mining industry. It provides a comprehensive system for the exchange and integration of a diverse array of solutions, spanning proprietary ecosystem products, third-party vendor solutions, and community-driven innovations.

Within this module, an introduction to a suite of proprietary products, each designed to address distinct aspects of the mining industry's needs. A strategic planning tool can be implemented to deliver in-depth insights into mining operations, facilitating optimized decision-making. Its integration could revolutionize strategic planning for a mining company in the USA, aligning operations with the latest ESG standards, and potentially enhancing operational efficiency by 30%. With regard to finance, the system's modular solution utilizes the data received to perform algorithms that can be tailored within the mining industry providing a solution that streamlines budgeting and financial analysis, enabling companies to better predict costs, create scenarios, evaluate metrics, build and manage financial planning, thus improving financial performance and ESG reporting accuracy.

Other advanced AI modeling solutions can offer predictive analytics for heap leach operations and foresight into mining scenarios, aiding in proactive management and strategic planning. A practical application could see a heap leach operation increasing yield by 15% through optimized leach forecast scenarios. As the first large language model (LLM) specifically for the mining industry, the system solution allows scenario analysis and comparisons via user prompts, enhancing decision-making processes (FIG. 4). In a scenario wherein operational scenarios are complex and varied, the system solution could facilitate decision-making that optimizes production efficiency and minimizes environmental impact.

A marketplace feature extends its offerings to include third-party vendor solutions, embracing a vendor-agnostic approach that ensures the mine value chain remains independent and fully democratized. This aspect is critical for integrating advanced AI models that can, for example, improve ore grade prediction, directly impacting the efficiency and sustainability of mining operations worldwide. By encouraging contributions from the mining community, the marketing feature fosters a culture of innovation and shared success. This open collaboration model invites individuals to develop and share innovative solutions, benefiting both the industry and the creators through a revenue-sharing model.

The marketplace may comprise an online hub for the mining and earth sciences sectors, offering a seamless marketplace where all stakeholders—scientists, consultants, technology and equipment vendors, investors, and service providers—can access, share, and transact valuable information, services, and products. With an intuitive, AI-driven structure that integrates seamlessly within the computer system of the present invention, this platform transcends traditional marketplace boundaries, becoming an essential resource for industry innovation, strategic decisions, and real-time intelligence. In some embodiments, the marketplace may provide an inclusive ecosystem for technology solutions specific to mining, enabling easy access to products, AI models, and applications from all vendors, including external vendors and users.

The marketplace may provide access to AI agents, optimization engines, and AI models. The marketplace may enable technology vendors to list APIs, integration modules, AI models, and other applications that work seamlessly within the computer system of the present invention. In a mining context, this includes everything from mineral processing software to IoT devices for mine monitoring. This could also be applied to a plurality of other fields. The marketplace may comprise a dynamic marketplace where community-built solutions, created using the low-code tools of the present invention, can be listed for purchase, subscription, or pay-per-use. This fosters an innovative environment where users can develop unique applications tailored to niche needs and market them directly to the industry.

All technologies listed are designed to operate smoothly within the present invention, creating a unified experience that eliminates the usual complexities of cross-platform integration. The marketplace may offer diverse pricing and usage options—subscription, one-time purchase, or pay-as-you-go—based on creator preferences, ensuring affordability and accessibility for users with different needs and budgets. By housing both proprietary and community-generated content, this becomes a vibrant marketplace that encourages user engagement, innovation, and rapid deployment of cutting-edge tools for optimized mining operations.

In some embodiments, the marketplace may comprise functionality offering the exchange of services. The marketplace may comprise a specialized consultancy hub for services, providing tailored matchmaking for individual consultants and firms across diverse disciplines. Independent consultants and firms may list their profiles, portfolios, and specialized services, allowing companies to connect directly with experts for targeted projects or due diligence tasks. Utilizing Graph Neural Networks (GNN), the matching process can be enhanced by analyzing skill sets, project histories, requirements, and reviews to ensure clients find the best fit based on experience and expertise. The marketplace may also list its experts, adding credibility and providing direct access to specialized services, particularly valuable for projects requiring deep AI or data analysis expertise. The intelligent GNN-based recommendation engine may ensure that companies find the ideal consultants for highly specialized tasks, enhancing project outcomes and efficiency. The marketplace may bring the freelancing model to any given sector, making it easier than ever for companies to source on-demand expertise while allowing consultants to reach new clients and expand their portfolios within a focused, industry-specific environment.

The marketplace may comprise a consolidated environment for investors, commodity traders, and financial analysts to access real-time information on market conditions, commodity prices, and promising investment opportunities in any given field. The marketplace may comprise a specialized section where investment meets financial analysis, allowing users to view curated news, live commodity prices, and key industry updates powered by partners like Bloomberg™, S&P™, and others. Investors are provided with personalized suggestions of products relevant to their interests, enhancing their financial modeling and investment planning processes. Equipped with data-driven tools and real-time market intelligence, investors may make smarter, AI-powered decisions supported by historical trends, predictive analytics, and up-to-date pricing information through the marketplace. The marketplace may offer a one-stop platform for investment insights combined with predictive analytics and modeling, providing investors with a distinct edge in evaluating opportunities and market shifts. Unlike general financial platforms, the marketplace may support nuanced, data-driven decisions with industry-specific AI tools, news, and financial models.

The marketplace may comprise a central knowledge repository for the mining industry, promoting content creation, collaboration, and learning through a range of media and resources. The marketplace may allow users to publish articles, case studies, and insights, creating a rich, collaborative knowledge base on topics like AI, environmental impact, and more. The information posted in the marketplace may comprise informative infographics, instructional videos, industry-focused podcasts, and more. In some embodiments, the marketplace may feature a library of scientific publications available through subscription or membership, providing access to leading research and innovations. The marketplace may enable individuals and organizations to contribute and access industry-specific knowledge, facilitating peer learning and broadening insights into industries. With a focus on multimedia and interactive learning, the marketplace goes beyond traditional publications, offering an engaging, comprehensive resource for professional development and industry trends.

In some embodiments, the marketplace is designed to transform how communities interact with information, services, and technology. Whether for equipment sourcing, consultancy services, investment insights, or knowledge sharing, the present invention is set to redefine industry standards and become an invaluable resource for all industry stakeholders. This platform will serve not only as a marketplace but as a cornerstone for modern, data-driven decision-making, sustainable growth, and technological innovation across any given sector.

Example 6: Consider a consultant developing an AI-driven water management system, shared on the marketplace feature. The system can leverage real-time data analysis, and reduce water usage by up to 25% in mining operations, promoting sustainability and aligning with global ESG trends.

The integrated system solutions provide an integrative approach ensuring a robust ecosystem supporting the mining value chain's entirety. It not only democratizes access to innovative tools and solutions but also aligns with global economic and environmental trends, including ESG, EV, BRICS, and safety, propelling the mining industry towards greater efficiency, sustainability, and profitability.

By embracing this comprehensive system, mining operations can navigate the complexities of modern mining, from adhering to stringent ESG criteria and capitalizing on the EV revolution to meeting safety standards and leveraging global economic opportunities. This strategic alignment not only enhances operational capabilities but also positions companies to thrive in the evolving global landscape, underscoring the significant commercial potential innovations.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer-readable medium may be transmitted using any appropriate medium, including but not limited to wireless, wireline, optical fiber cable, R. F, Bluetooth, storage media, computer buses, etc., or any suitable combination of the foregoing. Computer program code for carrying out operations for aspects of the present disclosure may be written in any combination of one or more programming languages, including an object-oriented programming language such as Java, Smalltalk, C #, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special-purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft®.NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

The present invention may comprise or implement a neural network for machine learning tasks. The neural network may be stored, trained, and/or executed entirely on the user's computer, partly on the user's computer, as a stand-alone software package, partly on the user's computer, and partly on a remote computer or entirely on the remote computer or server. The neural network may be stored in the form of program code, as described above. The neural network, in some embodiments, may be a perceptron neural network, a feed-forward neural network, a multilayer perceptron neural network, a convolutional neural network, a radial basis functional neural network, a recurrent neural network, a long short-term memory neural network, a sequence-to-sequence neural network model, a modular neural network, or the like.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

Reference numbers recited herein, in the drawings, and in the claims are solely for ease of examination of this patent application and are exemplary. The reference numbers are not intended in any way to limit the scope of the claims to the particular features having the corresponding reference numbers in the drawings.

What is claimed is:

1) A computer system (1000) for providing context and enabling processing of a plurality of inputs through a low-code customizable layered functionality, the system (1000) comprising:
a) a cloud server (1100) comprising:
i) a data lake comprising a plurality of data sets, each data set
comprising raw data having one or more data types;
ii) a knowledge graph communicatively coupled to the data lake, comprising one or more code engines, each code engine corresponding to a data type, configured to accept raw data having the data type as input and generate contextual processed data based on the raw data as output, further comprising the contextual processed data generated by each code engine of the one or more code engines;
iii) a context-generation Artificial Intelligence (AI) model trained by a data set comprising the knowledge graph, configured to accept natural language data as input and, if the knowledge graph does not contain a code engine capable of accommodating the natural language input, generate a new code engine based on the natural language data as output; and
iv) computer-readable instructions for:
A) receiving (1102) the natural language input, wherein the natural language input comprises a request for a data set of the plurality of data sets of the data lake;
B) identifying (1104) one or more data types corresponding to the request for the data set of the natural language input;
C) querying (1106) the knowledge graph for a requested code engine configured to generate contextual processed data based on raw data having the data type corresponding to the request for the data set of the natural language input;
D) inputting (1108), if the requested code engine is found, the data set into the requested code engine;
E) returning (1110), if the requested code engine is found, the contextual processed data outputted by the requested code engine;
F) inputting (1112), if the requested code engine is not found, the natural language input and the data set into the context-generation AI model;
G) inputting (1114), after the new code engine is generated by the context-generation AI model, the data set into the new code engine;
H) returning (1116), after the new code engine is generated, the contextual processed data outputted by the new code engine; and
I) adding (1118) the new code engine to the knowledge graph;
b) a processor (1200) communicatively coupled to the cloud server (1100), configured to execute computer-readable instructions; and
c) a memory component (1300) operatively coupled to the processor (1200), comprising computer-readable instructions for:
i) accepting (1302) the natural language input from a user;
ii) inputting (1304) the natural language input to the cloud server (1100); and
iii) receiving (1306) the contextual processed data from the cloud server (1100).

2) The system (1000) of claim 1, wherein the knowledge graph comprises a plurality of code engines grouped in proximity based on the data type corresponding to each code engine.

3) The system (1000) of claim 1, wherein the context-generation AI model comprises a machine learning model, a large language model, a structured model, a convolutional neural network, a recurrent neural network, or a combination thereof.

4) The system (1000) of claim 1, wherein the memory component (1300) further comprises a natural language processing model configured to accept natural language as input and generate conversational responses as output, wherein the natural language input comprises a plurality of text inputs generated through user interaction with the natural language processing model.

5) The system (1000) of claim 1, wherein the cloud server (1100) further comprises a marketplace database comprising a plurality of marketplace code engines, wherein the memory component (1300) further comprises computer-readable instructions for accessing (1308) the marketplace database and displaying (1310) the plurality of marketplace code engines.

6) The system (1000) of claim 5, wherein the cloud server (1100) further comprises computer-readable instructions for receiving (1120) an input code engine from the user and adding (1122) the input code engine to the knowledge graph, wherein the input code engine is sourced from the user, the marketplace database, or a combination thereof.

7) The system (1000) of claim 1, wherein the memory component (1300) further comprises computer-readable instructions for receiving (1312) a second natural language input, wherein the second natural language input comprises a request to execute one or more operations based on the contextual processed data, a request to transform the contextual processed data, a request for generating a relationship between the contextual processed data and a separate data set, or a combination thereof;
wherein the cloud server (1100) further comprises computer-readable instructions for receiving (1124) the second natural language input, and executing the request of the second natural language input on the contextual processed data.

8) The system (1000) of claim 1, wherein the one or more data types of each data set of the data lake comprise 3D visualization data, blast hole data, drill hole data, block model data, point cloud data, equipment operational data, equipment health data, operator data, mineral processing data, geotechnical data, safety data, or a combination thereof.

9) The system (1000) of claim 1, wherein the one or more data types of each data set of the data lake are specific to utility operations, water operations, lumber operations, business operations, agriculture and farming operations, or a combination thereof.

10. A non-transitory computer medium for providing context and enabling processing of a plurality of inputs through a low-code customizable layered functionality, that, when executed by a processor (1200) configured to execute computer-readable instructions, is configured to:
a) receive (1102) a natural language input, wherein the natural language input comprises a request for a data set of a data lake comprising a plurality of data sets, each data set comprising raw data having one or more data types;
b) identify (1104) a data type corresponding to the request for the data set of the natural language input;
c) query (1106) a knowledge graph communicatively coupled to the data lake, comprising one or more code engines, each code engine corresponding to a data type, configured to accept raw data having the data type as input and generate contextual processed data based on the raw data as output, further comprising the contextual processed data generated by each code engine of the one or more code engines, for a requested code engine configured to generate contextual process data based on raw data having the data type corresponding to the request for the data set of the natural language input;
d) input (1108), if the requested code engine is found, the data set into the requested code engine;
e) return (1110), if the requested code engine is found, the contextual processed data outputted by the requested code engine;
f) input (1112), if the requested code engine is not found, the natural language input and the data set into a context-generation Artificial Intelligence (AI) model trained by a data set comprising the knowledge graph, configured to accept natural language data as input and, if the knowledge graph does not contain a code engine capable of accommodating the natural language input, generate a new code engine based on the natural language data as output;
g) input (1114), after the new code engine is generated by the context-generation AI model, the data set into the new code engine;
h) return (1116), after the new code engine is generated, the contextual processed data outputted by the new code engine; and
i) add (1118) the new code engine to the knowledge graph.

11. The non-transitory computer medium of claim 10, wherein the knowledge graph comprises a plurality of code engines grouped in proximity based on the data type corresponding to each code engine.

12. The non-transitory computer medium of claim 10, wherein the context-generation AI model comprises a machine learning model, a large language model, a structured model, a convolutional neural network, a recurrent neural network, or a combination thereof.

13. The non-transitory computer medium of claim 10, wherein the natural language input comprises a plurality of text inputs generated through user interaction with a natural language processing model configured to accept natural language as input and generate conversational responses as output.

14. The non-transitory computer medium of claim 10, wherein the non-transitory computer medium is further configured to access (1308) a marketplace database comprising a plurality of marketplace code engines and display (1310) the plurality of marketplace code engines.

15. The non-transitory computer medium of claim 14, wherein the non-transitory computer medium is further configured to receive (1120) an input code engine from a user and add (1122) the input code engine to the knowledge graph, wherein the input code engine is sourced from the user, the marketplace database, or a combination thereof.

16. The non-transitory computer medium of claim 10, wherein the non-transitory computer medium is further configured to:
a) receive (1312) a second natural language input, wherein the second natural language input comprises a request to execute one or more operations based on the contextual processed data, a request to transform the contextual processed data, a request for generating a relationship between the contextual processed data and a separate data set, or a combination thereof; and
b) execute (1126) the request of the second natural language input on the contextual processed data.

17. The non-transitory computer medium of claim 10, wherein the one or more data types of each data set of the data lake comprise 3D visualization data, blast hole data, drill hole data, block model data, point cloud data, equipment operational data, equipment health data, operator data, mineral processing data, geotechnical data, safety data, or a combination thereof.

18. The non-transitory computer medium of claim 10, wherein the one or more data types of each data set of the data lake are specific to utility operations, water operations, lumber operations, business operations, agriculture and farming operations, or a combination thereof.

19. A method implemented on a computer for providing a low-code customizable layered functionality to integrate and facilitate data-driven decision-making, comprising:
a) using a processor (1200) of the computer to collect data from device Internet of Things (IoT) sensors, operational databases and third-party application programming interfaces;
b) using the processor (1200) of the computer to gather said data and push to a system (1000);
c) using the processor (1200) of the computer to integrate the data within the system (1000) utilizing an integrated graph model ontology;
d) using the processor (1200) of the computer to process data within an open-system distributed event streaming system (1000);
e) providing end-to-end encryption within the system (1000) to secure data;
f) using the system (1000) to formulate relationships between the data;
g) using the system (1000) to analyze the data gathered and perform calculations with the use of algorithms;
h) using the system (1000) to generate code engines configured to process input data types; and
i) using the system (1000) to facilitate user feedback.

20. The computer-implemented method as claimed in claim 19, wherein the system (1000) programming interfaces integrate across a network to share said data.
